(19) United States
(12) Patent Application Publication
(10) Pub. No.: US 2025/0353206 A1
(43) Pub. Date: Nov. 20, 2025

(54) DIAMOND WIRE CUTTING MACHINE

(71) Applicant: HI-TECH WIRES ASIA CO., LTD, Thuan An (VN)

(72) Inventors: Jean-Baptiste Pouradier, Thuan An (VN); Doan Thùy Nguyen, Thuan An (VN); Phú Trung Nguyen, Thuan An (VN); The Ánh Lai, Thuan An (VN)

(21) Appl. No.: 18/918,397

(22) Filed: Oct. 17, 2024

(30) Foreign Application Priority Data
May 17, 2024 (FR) 2405058

(51) Int. Cl. B26D 7/26; B26D 1/00; B26D 1/553

(52) U.S. Cl. CPC B26D 7/2614; B26D 1/0006; B26D 1/553; B26D 2001/002; B26D 2001/008

(57) ABSTRACT

A diamond wire cutting machine includes a spool on which a diamond wire is wound. The spool includes two end flanges having respective frustoconical faces adapted, by cooperation of shape with frustoconical faces of two adapters, to center the spool on an axis of revolution. A drum extends from one of the end flanges to another of the end flanges. The drum includes a cylindrical outer face of circular cross-section on which the diamond wire is wound. The drum defines a central hole through which a drive shaft passes. The drum and the end flanges form a single plastic block.

### CROSS-REFERENCE TO RELATED APPLICATION

Pursuant to 35 U.S.C. § 119(a), this application claims priority to, and the benefit of the filing date of, French Patent Application Serial No. FR2405058, filed May 17, 2024, for “MACHINE DÉDECOUPE Á L'AIDE D'UN FIL DIAMANTÉ,” which translates in English to “DIAMOND WIRE CUTTING MACHINE,” the disclosure of which French patent application is hereby incorporated in its entirety herein by this reference.

### TECHNICAL FIELD

The disclosure relates to a diamond wire cutting machine and to a spool for producing this cutting machine.

### BACKGROUND

Diamond wire cutting machines are used to cut very hard parts, such as metal or silicon ingots. In these machines, diamond wire is unwound from a pay-off spool (“sending spool”) to a take-up spool (“receiving spool”). The pay-off spool delivers new diamond wire, which is used to cut the workpiece. Once the part or parts have been cut, the used diamond wire is wound onto the take-up spool. As a result, the take-up spool essentially contains used diamond wire.

When cutting the workpiece, the tension exerted on the diamond wire is high. As a result, the radial pressure exerted by the diamond wire on the drums of the pay-off spool and of the take-up spool is very high. This pressure is called “radial pressure” because it compresses the drum in the direction of its axis of revolution. In addition, the speed of the diamond wire is also very high when cutting a workpiece. As a result, the pay-off spool and the take-up spool rotate very quickly on their axes of revolution. Because of this, the centering of the pay-off spool and the take-up spool on their respective axes of revolution must be very precise to avoid vibrating the diamond wire as much as possible. Vibration of the diamond wire deteriorates the cutting process.

Because of the above constraints, the pay-off spool and the take-up spool are usually made of metal. Firstly, such metal spools deform very little in response to the radial pressure exerted by the diamond wire on their drums. Secondly, the dimensional errors on the dimensions of these metal spools are at least five times smaller than the dimensional errors that would be observed if the spools were made from a softer material, such as plastic or resin. The smaller the dimensional errors on the spool dimensions, the more precise its centering on its axis of revolution. In this way, the use of metal spools reduces diamond wire vibrations when cutting the workpiece.

However, metal spools also have a number of disadvantages. For example, they are expensive and heavy. As a result, they are often returnable, forcing users of cutting machines to return them to the diamond wire manufacturer.

To reduce the weight of metal spools used in diamond wire cutting machines, application CN211491757U proposes to produce the spool drum using a plastic molded onto a metal insert. In the spool of application CN211491757U, the spool flanges are still made of metal to ensure good centering. This spool is effectively lighter than an all-metal spool. However, it is complicated to manufacture because it requires the assembly of different parts in different materials, which makes its manufacture more complex, and therefore the construction of the cutting machine that incorporates it is also more complex. In addition, because of the presence of metal parts, the weight of the spool remains quite high, making handling and therefore the use of the cutting machine more complex.

### BRIEF SUMMARY

Embodiments of the disclosure aim to remedy at least one of the aforementioned drawbacks by providing a cutting machine that is simpler to build and operate.

To this end, the disclosure concerns a diamond wire cutting machine, comprising:
a drive shaft extending along an axis of revolution;
a motor capable of driving the drive shaft in rotation, about its axis of revolution, sometimes in one direction and sometimes in the opposite direction;
two adapters each fixed to the drive shaft, each of these adapters comprising a frustoconical centering face centered on the axis of revolution, these frustoconical faces facing one another; and
a spool on which the diamond wire can be wound when a workpiece is cut by the cutting machine, this spool being immobilized in rotation and translation on the drive shaft by the two adapters, this spool comprising:
   two end flanges having respective frustoconical faces capable, by form-fitting cooperation with the frustoconical faces of the adapters, of centering the spool on the axis of revolution; and
   a drum extending from one end flange to the other end flange, the drum comprising:
      a cylindrical outer face of circular cross-section on which the diamond wire is wound; and
      a central hole through which the drive shaft passes,
wherein the drum and end flanges form a single plastic block.

### BRIEF DESCRIPTION OF THE DRAWINGS

Embodiments of the disclosure will be better understood on reading the following description, given solely by way of non-limiting example and made with reference to the drawings in which:

FIG. 1 is a schematic illustration of the architecture of a diamond wire cutting machine;

FIG. 2 is an exploded perspective view of a shaft and spool from the machine shown in FIG. 1;

FIG. 3 is a perspective view of a spool mounted on a shaft of the machine shown in FIG. 1;

FIG. 4 is a perspective view of an adapter for the machine shown in FIG. 1;

FIG. 5 is a perspective view of a spool from the machine shown in FIG. 1;

FIG. 6 is a perspective view of a longitudinal section of the spool shown in FIG. 5; and

FIG. 7 is a partial view, in longitudinal section, of the spool mounted on the shaft of the machine shown in FIG. 1.

### DETAILED DESCRIPTION

In this description, the terminology, conventions and definitions of the terms used in this text are introduced in Chapter I. Then, a detailed example of a realization mode is described in Chapter II with reference to the figures. In Chapter III, variants of this embodiment are presented. Finally, the advantages of the various embodiments are described in Chapter IV.

### Chapter I: Definitions, Terminology and Conventions

In the figures, the same references are used to designate the same elements.

In the remainder of this description, features and functions well known to the person skilled in the art are not described in detail.

The figures are oriented with respect to an orthogonal XYZ reference frame, where the X and Y directions are horizontal and the Z direction is vertical.

The “*” symbol denotes scalar multiplication.

The expression “an element made of material A” or “a material A element” means that material A represents 90% or 95% of the mass of the element.

A “hard material” is one whose hardness on the Mohs scale is greater than 5 or 5.5.

The terms “outer” and “external” refer to the parts of a piece that are furthest away from its axis of revolution.

The terms “inner” and “internal” refer to the parts of a piece that are closest to its axis of revolution.

### Chapter II: Example of a Realization Mode

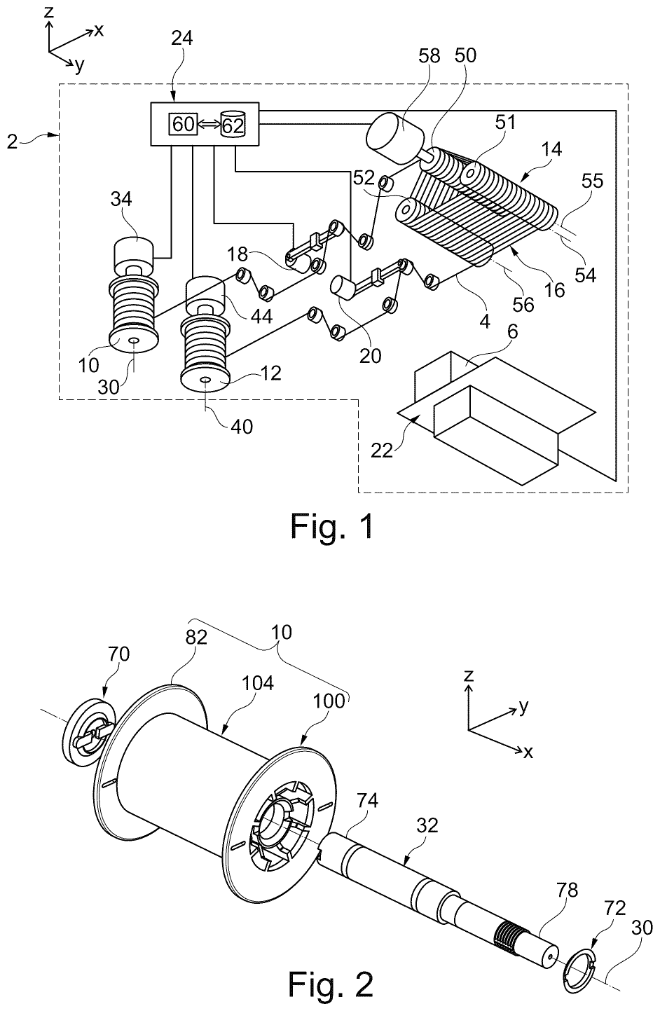

FIG. 1 shows a machine 2 for cutting with a diamond wire 4. By way of illustration, this machine 2 is used to cut an ingot 6, made of hard material, into several slices. To this end, the machine 2 includes:
a pay-off spool 10 on which the new diamond wire is initially wound,
a take-up spool 12 on which the diamond wire used during operation of machine 2 is wound,
a group 14 of several pulleys around which diamond wire is wound to create a web 16 of diamond wire segments,
sensors 18, 20 for diamond wire tension,
a motorized plate 22 on an upper face of which the ingot 6 is fixed without any degree of freedom, and
an electronic unit (24) for controlling the various motors of machine 2.

During operation of machine 2, spool 10 rotates on itself around an axis 30 of revolution. In FIG. 1, axis 30 is shown as vertical to simplify the schematic illustration of machine 2. Preferably, however, axis 30 is horizontal. To this end, the spool 10 is fixed, without any degree of freedom in rotation or translation, on a shaft 32 (FIG. 2) driven in rotation by an electric motor 34.

Similarly, the spool 12 rotates on itself around an axis 40 of revolution. In FIG. 1, axis 40 is shown as vertical to simplify the schematic illustration of machine 2. Preferably, however, axis 40 is horizontal. The spool 12 is fixed, without any degree of freedom in rotation or translation, on a shaft driven in rotation by an electric motor 44.

The wire 4 unwound from the spool 10 is wound several times around the pulley group 14 to form the web 16 of parallel diamond wire segments. Here, for example, group 14 comprises three pulleys 50, 51, and 52, each of which rotates on itself about a respective axis of revolution. Here, pulleys 50, 51, and 52 rotate about axes 54, 55, and 56, respectively. These axes 54, 55, and 56 are parallel to the Y direction. Here, axes 54, 55, and 56 are each arranged on a respective vertex of an equilateral triangle whose base is horizontal.

In this example, each pulley 50, 51, and 52 is driven in rotation about its respective axis of revolution by a controllable electric motor. To simplify FIG. 1, only the electric motor 58 driving pulley 50 is shown.

The web 16 is formed by segments of wire 4 running parallel to one another between axes 55 and 56. Here, the segments of the web 16 each extend parallel to the X direction. The segments of web 16 are spaced from one another in the Y direction by a regular pitch. For example, web 16 comprises more than five or ten segments of wire 4 in order to cut several slices simultaneously from ingot 6.

Sensor 18 measures the tension of wire 4 between spool 10 and pulley group 14. Sensor 20 measures the tension of wire 4 between pulley group 14 and spool 12.

The motorized table 22 (also referred to herein as the “motorized plate” 22) moves the ingot 6 in the Z direction to bring it into contact with the web 16 and push it against the web 16 to cut it into parallel slices. Here, the motorized table 22 is also capable of moving the ingot 6 in the X direction to produce, for example, curved and not simply parallelepipedal slices.

Unit 24 controls the various motors of machine 2 to automatically cut ingot 6 into several slices. In particular, unit 24 controls pulley drive motors 34 and 44 to move wire 4 back and forth while unwinding new portions of wire 4 from spool 10 and, simultaneously, winding used portions of wire 4 onto spool 12. To this end, unit 24 typically controls motors 34, 44 and the motors of pulleys 50, 51, and 52 by alternating unwinding phases and winding phases. During each unwinding phase, motors 34, 44 and the motors of pulleys 50, 51, and 52 are controlled to unwind a length P1 of wire 4 from spool 10 and wind this same length P1 onto spool 12. During each winding phase, motors 34, 44 and the motors of pulleys 50, 51, and 52 are controlled to wind a length P2 of wire 4 onto spool 10 and unwind this same length P2 from spool 12. The length P2 is less than the length P1, so that the succession of unwinding and winding phases progressively leads to wire 4 being unwound almost completely from spool 10 and wound almost completely onto spool 12. For example, the length P2 is between 0.95*P1 and 0.999*P1 or between 0.98*P1 and 0.995*P1.

In addition, the motor 34 is generally controlled as a function of the wire 4 tension measured by the sensor 18 in order to control the wire 4 tension, during the unwinding and winding phases, to a first tension setpoint. Similarly, motor 44 is generally controlled as a function of the tension of wire 4 measured by sensor 20, in order to control the tension of wire 4, during the unwinding and winding phases, to a second tension setpoint.

To this end, unit 24 typically comprises a microprocessor 60 and memory 62 containing the instructions and data required to control the various motors of machine 2 when these instructions are executed by microprocessor 60.

The spool 10 and the mounting of this spool 10 on the shaft 32 will now be described with reference to FIGS. 2 to 7. Everything described below for the particular case of spool 10 and shaft 32 applies equally to spool 12 and the drive shaft on which it is mounted.

Two adapters 70, 72 (FIG. 2) are used to secure the spool 10 to the shaft 32 without any degree of freedom in rotation or translation.

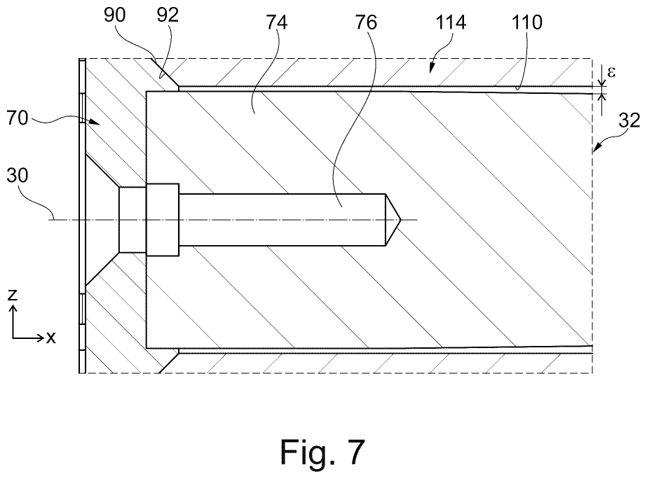

Adapter 70 is removable. To this end, the machine 2 comprises a mechanism for fastening the adapter 70 to the shaft 32. This fastening mechanism can be moved alternately and reversibly between a mounted position and an unmounted position. In the mounted position, adapter 70 secures spool 10 to shaft 32 in terms of translation and rotation. In the unmounted position, adapter 70 allows spool 10 to be removed from shaft 32. For example, in this embodiment, the fastening mechanism of adapter 70 comprises a threaded hole 76 (FIGS. 6 and 7), in a free end 74 (FIG. 2) of shaft 32, and a screw whose head presses adapter 70 against this free end 74 in the mounted position. To simplify the figures, the screw has not been shown. Adapter 70 has a through hole 80 (FIG. 4) for the screw's threaded shank. This hole 80 extends, for example, along axis 30, in the mounted position.

The free end 74 of shaft 32 is the end that is located on the opposite side to a proximal end 78 (FIG. 2) of this shaft 32. Proximal end 78 is that which is mechanically connected to motor 34 to drive shaft 32 in rotation.

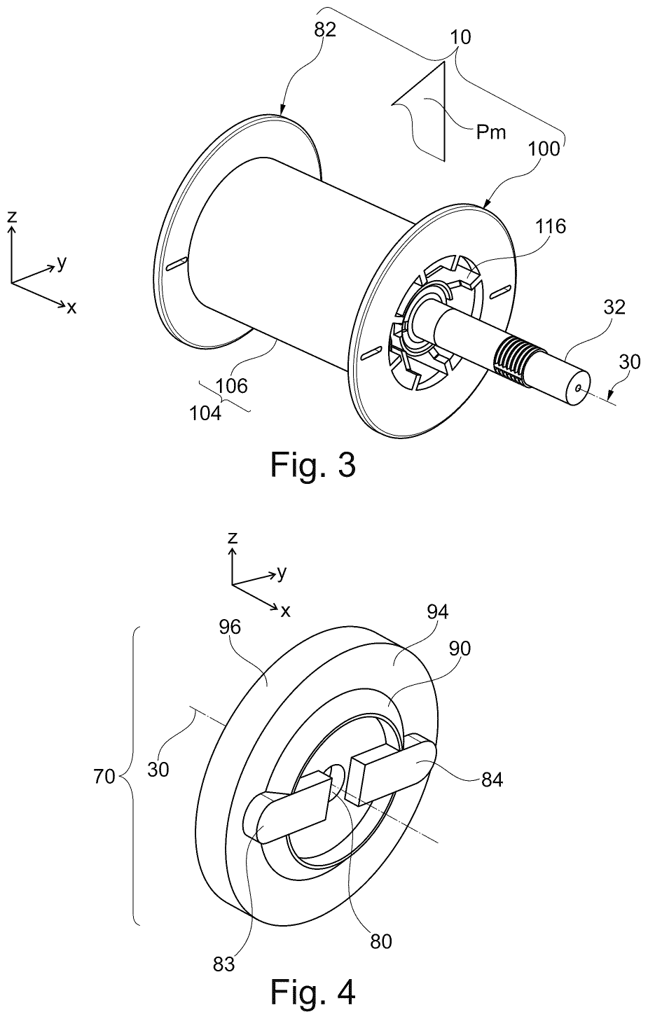

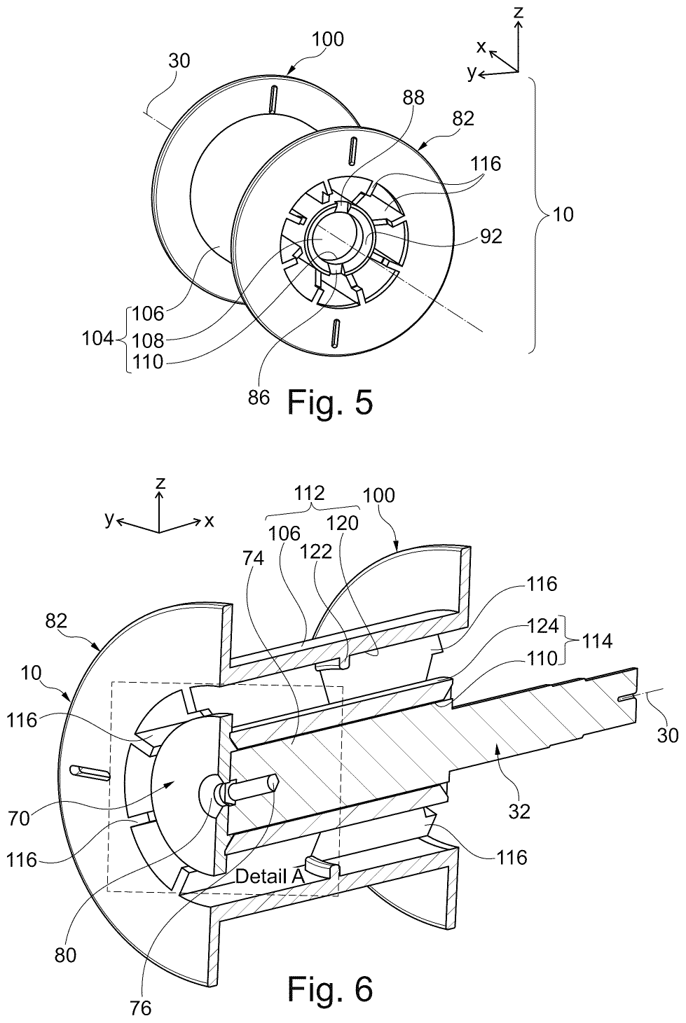

In the mounted position, adapter 70 secures the spool 10 against rotation by interlocking with complementary shapes in an end flange 82 (FIGS. 3, 5, 6) of spool 10. Here, for example, adapter 70 comprises two oblong protuberances 83, 84 (FIG. 4) located on either side of hole 80. In the mounted position, each of these protuberances 83, 84 is received inside, respectively, oblong recesses 86 and 88 (FIG. 5) provided in the flange 82 in order to immobilize, in rotation, the spool 10 on the shaft 32.

In the mounted position, the adapter 70 also centers the spool 10 on the axis 30 of revolution. To this end, adapter 70 has a frustoconical face 90 (FIG. 4), which, by cooperating with a corresponding frustoconical face 92 (FIG. 5) in flange 82, centers spool 10 on axis 30.

Face 90 is a truncated cone, i.e., the part of a cone located between two parallel planes. Here, these parallel planes are perpendicular to axis 30 in the mounted position. The directrix curve of this cone is a circle centered on axis 30. Its apex is located on the side of the proximal end 78. The angle at the apex of the cone is greater than 40° or 60° and, generally, less than 160° or 140°. For example, the apex angle is between 80° and 100°. Face 90 here forms a protrusion projecting from a flat inner face 94 (FIG. 4) of a disc 96 (FIG. 4) of adapter 70.

Face 92 has the same geometric characteristics as face 90, except that it is recessed towards the inside of spool 10.

As shown in FIG. 7, in the mounted position, the face 90 rests directly against the face 92 to center the spool 10 on the 30 axis.

Adapter 72 is attached to shaft 32 without any translational or rotational degrees of freedom. For this purpose, it is fixed to shaft 32 by any suitable fastening means. For example, it is held in place by a shoulder or press-fitted onto shaft 32. Adapter 72 is closer to the proximal end 78 of shaft 32 than adapter 70. Adapter 72 is positioned on shaft 32 in such a way that, when spool 10 is mounted on shaft 32 and locked in this mounted position by adapter 70, then an end flange 100 of spool 10 bears directly against adapter 72.

In a similar way to the adapter 70 described above, the adapter 72 immobilizes the spool 10 in translation and rotation when the flange 100 rests against the adapter 72.

Here, flange 100 is symmetrical to flange 82 with respect to a median plane Pm (FIG. 3) of spool 10. The median plane Pm is perpendicular to axis 30 when spool 10 is mounted on shaft 32. Under these conditions, adapter 72 has a frustoconical face and protuberances identical, respectively, to face 90 and protuberances 83, 84 of adapter 70 except that they face the distal end 74 (as referred to herein as the free end 74).

Typically, adapters 70 and 72 are made of metal.

In addition to the two flanges 82 and 100, the spool 10 has a drum 104, which mechanically connects the two flanges 82, 100. Drum 104 comprises:
an outer face 106 (FIGS. 5 and 6) on which the diamond wire is wound, and
a central hole 108 (FIG. 5) through which the shaft 32 passes in the mounted position.

Face 106 is a cylinder whose directrix curve is a circle of diameter D₁₀₆ and whose generatrix is parallel to axis 30 in the mounted position. Diameter D₁₀₆ is typically between 100 mm and 500 mm. The diameter D₈₂ of the flange 82 is greater than diameter D₁₀₆ and typically between 1.1*D₁₀₆ and 1.5*D₁₀₆. The length, in the X direction, of face 106 is between 150 mm and 800 mm.

The central hole 108 is delimited by an internal face 110 (FIGS. 5, 6, and 7) of the drum 104. Face 110 is a cylinder whose generatrix is a circle of diameter D₁₁₀ and whose generatrix is parallel to axis 30. Diameter D₁₁₀ is equal to D₃₂+ε, where D₃₂ is the diameter of shaft 32 at the emplacement of spool 10, and ε (FIG. 7) is a predetermined clearance. Diameter D₃₂ is typically between 20 mm and 50 mm. The clearance F is chosen so that, when the radial pressure exerted by wire 4 on drum 104 is at its maximum, face 110 does not come to bear directly on shaft 32. In this way, the clearance F facilitates assembly/disassembly of the spool 10. To this end, typically, the clearance F is greater than 0.01 mm or 0.1 mm. The clearance F is also typically less than 1 cm.

Drum 104 is designed to withstand a radial pressure exerted by the diamond wire wound on it of 50 MPa or more, preferably 100 MPa or more. Generally, drum 104 is not subjected to a radial pressure greater than 200 MPa, so it is not necessary for it to withstand such a radial pressure.

In this embodiment, the drum 104 comprises an outer tube 112, an inner tube 114 and radial fins 116. The outer tube 112 (FIG. 6) comprises:
an outer cylindrical face corresponding to the outer face 106 of the drum, and
an inner cylindrical face 120 (FIG. 6) facing axis 30.

The outer tube 112 also comprises a reinforcing rib 122 projecting from the inner face 120. Rib 122 is located in the median plane Pm and runs completely around axis 30.

The inner tube 114 (FIG. 6) is concentric with the outer tube 112 and is housed inside the outer tube 112. The inner tube 114 has an inner cylindrical face corresponding to the inner face 110 of the drum 104 and has an outer cylindrical face 124 (FIG. 6). In this embodiment, the frustoconical face 92 is formed in the end of inner tube 114, which also facilitates insertion of spool 10 onto shaft 32.

The fins 116 (FIG. 6) transfer some of the radial pressure exerted by the wire 4 to the inner tube 114, thereby increasing the rigidity of the drum 104. To this end, fins 116 extend radially from inner tube 114 to outer tube 112. The fins 116 also extend continuously, in the X direction, from flange 82 to flange 100. The fins 116 are uniformly distributed around axis 30. The number Nₐ of fins 116 is preferably even, so that each fin 116 is symmetrical to another fin 116 with respect to axis 30. Furthermore, the number Nₐ of fins 116 is advantageously in the range of eight to twelve. In this embodiment, the number Nₐ is equal to eight.

Again to increase the robustness of drum 104 and make spool 10 usable in machine 2, the thicknesses of tubes 112 and 114 and the thickness of fins 116 are each greater than 2 mm or 4 mm. Generally, the thicknesses of tubes 112 and 114 and the thickness of fins 116 are less than 10 mm or 8 mm.

The spool 10 is entirely and solely formed from a single and continuous block of plastic. In this embodiment, the spool 10 is entirely made in a mold comprising several shells, into which the molten plastic is injected. Once the spool 10 has been demolded, no further machining is required to adjust the dimensions of the spool 10, and, in particular, of the face 92 and cylindrical face 110. Thus, the flanges 82 and 100 and the drum 104 form a single block of uniform and continuous material. The fact that spool 10 is formed by molding a plastic is easily detected by examining the spool, as molding is a manufacturing process that leaves traces in the piece thus produced. The traces may be the location of the parting line, the location of the air intake chimneys, the location of the molten plastic introduction chimneys or others. Preferably, to achieve very high hardness, the plastic used to mold the spool 10 is PPS (polyphenylene sulfide) reinforced with glass fibers. Typically, glass fibers account for at least 20% or 30%, by volume, of the plastic. For example, the plastic used to mold spool 10 is PPS GF40, which contains 40% glass fibers.

### Chapter III: Variants

### Spool Variants:

Alternatively, the directrix curve of the frustoconical faces 90, 92 is not a circle. This non-circular directrix curve is preferably symmetrical with respect to the axis 30 of revolution. In this case, the protuberances 83, 84 can be omitted, as the frustoconical faces themselves prevent rotation of the spool 10 on the shaft 32 in the mounted position, by virtue of their shape.

The frustoconical face 92 can also be formed, in whole or in part, in the ends of the fins 116 located at the flange 82 or in the end of the outer tube 112 located at the flange 82.

Other embodiments of the drum 104 are also possible. For example, as an alternative, tubes 112 and 114 and radial fins 116 are replaced by a single tube whose thickness is sufficient for its outer face to form the outer face 106 of the drum 104, and whose inner face defines the perimeter of central hole 108.

The drum 104 and flanges 82, 100 can be machined rather than molded. For example, a single block of plastic is machined so that the drum 104 and flanges 82, 100 form a single block of plastic. In this case, the geometry of the drum 104 and flanges 82, 100 must be adapted to such machining. For example, the embodiment described in the previous paragraph is suitable for manufacturing spool 10 by machining a block of plastic, as the fins 116 are omitted. However, in the absence of fins 116, the drum 104 is less openworked and therefore heavier.

Alternatively, the spool 10 can be fitted with additional parts. For example, the spool 10 can be fitted with an end cap, which can be clipped onto one of the flanges 82 or 100. This clip-on cap can be used, for example, as a removable label holder. In this case, the clip-on cap can be removed before the spool 10 is mounted on the drive shaft. However, if the clip-on cap does not obstruct the central hole 108 and does not interfere with the centering of the spool 10 by positive fit with the adapters 70, 72, then the clip-on cap can also be left in place even when the spool 10 is in use in the machine 2.

The spool 10 can also be made of plastics other than glass-fiber-reinforced PPS. For example, in a variant, the glass fibers are replaced by other fibers capable of reinforcing the plastic, such as metal fibers. In a simplified variant, the plastic has no reinforcing fibers at all. In another variant, PPS is replaced by another special plastic to achieve the desired hardness. This other special plastic can be one of the plastics belonging to the group consisting of PPA (polyphthalamide), PA (polyamide), PBT (polybutylene terephthalate), PC (polycarbonate), PEEK (Polyetheretherketone), POM (Polyoxymethylene), PEI (Polyetherimides), PEK (Polyetherketone), PAI (Polyamide-Imide), PPSU (Polyphenylsulfone), PSU (Polysulfone) and PES (Polyethersulfone).

### Other Variants:

There are many other possible designs for the cutting machine 2. For example, the axes of revolution 30 and 40 of spools 10 and 12 can be vertical.

One of the spools 10 and 12 can be conventionally made of metal. In this case, for this metal spool, adapters 70 and 72 can be omitted, as the diameter Duo can then be adjusted very precisely to lie, for example, between D₃₂ and D₃₂+3 μm. Preferably, spool 12 is made of metal in this case.

Pulley group 14 may comprise a different number of pulleys. For example, in one variant, group 14 comprises only the two pulleys 51 and 52. In another variant, group 14 comprises more than three pulleys.

In another embodiment, the plate 22 (or table 22) is stationary, and it is the pulley group 14 that moves in the Z and/or X directions.

In a simplified embodiment, the motorized plate 22 only moves the ingot 6 in the Z direction.

In another simplified embodiment, one of the sensors 18 and 20 is omitted. In another variant, both sensors 18 and 20 are omitted. In this case, the motor for rotating the spool 10 or 12 is not controlled as a function of the tension of the wire 4 wound on this spool 10 or 12.

Other mechanisms for fastening adapter 70 to the distal end 74 of shaft 32 are possible. For example, instead of being screwed onto the distal end 74, the adapter 70 is clipped onto the distal end 74.

Alternatively, adapter 72 may form a single block of material with shaft 32. Conversely, in another variant, adapter 72 is also removable.

Several of the variants described above can be combined in a single embodiment.

### Chapter IV: Advantages of the Described Embodiments

The fact that the end flanges 82, 100 are made of plastic reduces the weight of the spool 10, thus simplifying the use of the cutting machine 2. In addition, this reduction in spool weight is achieved without any deterioration in the spool's 10 centering on the drive shaft 32, while still allowing the flanges 82, 100 and drum 104 to be manufactured by molding. Indeed, the dimensional tolerances of molded plastic parts are much greater than those of the same parts made of metal. Because of this, it was expected that spool centering using molded plastic flanges would be much poorer than using metal flanges. It is assumed that it is for this reason that, in application CN211491757U, the end flanges are made of steel and not plastic. However, it has been found that the dimensional errors observed on molded plastic parts are essentially caused by the plastic shrinkage phenomenon that occurs when molten plastic cools. As a result, at a given location, the error in the diameter of the frustoconical face 92 is much greater than if the flange were made of metal. However, in the case of frustoconical face 92, the shrinkage phenomenon is uniform over the entire periphery of this frustoconical face 92. Because of this, the frustoconical plastic face 92 is as well centered on the axis 30 of revolution as if it were made of metal. In this way, the plastic end flanges 82, 100 ensure that the centering of the spool 10 on the axis 30 of revolution is sufficiently precise to be suitable for use of the spool 10 in a diamond wire cutting machine.

In addition, the fact that the drum 104 and end flanges 82, 100 are made from the same block of plastic substantially simplifies the manufacture of the spool 10, since the flanges 82, 100 and drum 104 can be molded together in a single operation. Simplifying the construction of the spool 10 also simplifies the construction of the cutting machine 2.

The use of outer tube 112 and inner tube 114 mechanically connected to each other by radial fins 116 further reduces the weight of spool 10, while still being able to withstand the radial pressure exerted by diamond wire 4 wound on this spool 10.

The fact that the number of radial fins 116 is between eight and twelve, inclusive, makes it possible to obtain a drum 104 that withstands the radial pressure exerted by the diamond wire 4 during its use in the cutting machine 2, while leaving sufficient space between the fins 116 to facilitate demolding of the spool 10.

The fact that the thicknesses of the inner tube 114, outer tube 112, and radial fins 116 are greater than or equal to 2 mm provides the strength required to withstand the radial pressure exerted by the diamond wire 4 when cutting a workpiece.

The fact that spool 10 is made from a single block of molded plastic simplifies its manufacture compared with a spool such as the one described in application CN211491757U. Indeed, in application CN211491757U, the spool additionally includes a metal insert to reinforce its drum.

The use of glass-fiber-reinforced PPS, which is an unusual plastic for spool production, results in a spool that withstands the radial pressure exerted by the diamond wire 4 when cutting a part, while limiting the amount of material used to produce it.

1. A diamond wire cutting machine, comprising:
a drive shaft extending along an axis of revolution;
a motor capable of driving the drive shaft in rotation, about its axis of revolution, sometimes in one direction and sometimes in an opposite direction;
two adapters each fixed to the drive shaft, each of the adapters comprising a frustoconical face centered on the axis of revolution, the frustoconical faces facing one another;
a spool on which a diamond wire can be wound when a workpiece is cut by the cutting machine, the spool being immobilized in rotation and translation on the drive shaft by the two adapters, the spool comprising:
two end flanges having respective frustoconical faces capable, by form-fitting cooperation with the frustoconical faces of the adapters, of centering the spool on the axis of revolution; and
a drum extending from one of the end flanges an other of the end flanges, the drum:
comprising a cylindrical outer face of circular cross-section on which the diamond wire is wound; and
defining a central hole through which the drive shaft passes,
wherein the drum and the end flanges form a single plastic block.

2. The cutting machine of claim 1, wherein the spool further comprises:
an outer tube extending from the one of the end flanges to the other of the end flanges, an outer cylindrical face of the outer tube forming the cylindrical outer face of the drum;
an inner tube concentric with the outer tube and housed inside the outer tube, an inner cylindrical face of the inner tube delimiting a periphery of the central hole; and
radial fins extending radially from the inner tube to the outer tube and continuously from the one of the end flanges to the other of the end flanges.

3. The cutting machine of claim 2, wherein the radial fins are uniformly distributed around the axis of revolution and a number of the radial fins is between eight and twelve, inclusive.

4. The cutting machine of claim 2, wherein a thicknesses of the inner tube and the outer tube and a thickness of each of the radial fins is greater than or equal to 2 mm.

5. The cutting machine of claim 1, wherein the drum and the end flanges are formed entirely and solely from a single block of molded plastic.

6. The cutting machine of claim 1, wherein the single plastic block is made of PPS (polyphenylene sulfide) reinforced with glass fibers.

7. The cutting machine of claim 1, wherein the drum of the spool is able to withstand a radial pressure exerted by the diamond wire wound on the drum greater than 50 MPa.

8. The cutting machine of claim 1, wherein a difference between a diameter of the drive shaft and a diameter of the central hole of the spool is greater than 10 μm.

9. The cutting machine of claim 1, wherein the spool is either a pay-off spool that initially contains the diamond wire or a is a take-up spool that contains the diamond wire after it has been used to cut the workpiece.

10. A spool, suitable for use in a cutting machine, for winding thereon a diamond wire during cutting of a workpiece by the cutting machine, the spool being adapted to be immobilized, in rotation and translation, on a drive shaft of the cutting machine by two adapters of the cutting machine, the spool comprising:
two end flanges with respective frustoconical faces capable, by form-fitting cooperation with frustoconical faces of the adapters, of centering the spool on an axis of revolution; and
a drum extending from one of the end flanges an other of the end flanges, the drum:
comprising a cylindrical outer face of circular cross-section on which the diamond wire is wound; and
defining a central hole through which the drive shaft passes,
wherein the drum and the end flanges form a single plastic block.
